(19) United States
(12) Patent Application Publication
(10) Pub. No.: US 2009/0231091 A1
(43) Pub. Date: Sep. 17, 2009

(54) WALL-MOUNTED ACCESS/SECURITY CONTROL PANEL

(75) Inventors: Robert A. Burwell, Kensington, NH (US); Andrew J. Pavlik, Raymond, NH (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SURVEILLANCE SPECIALTIES LTD., Wilmington, MA (US)

(21) Appl. No.: 12/046,972

(22) Filed: Mar. 12, 2008

(51) Int. Cl. G08B 13/00

(52) U.S. Cl. 340/5.2

(57) ABSTRACT

In one aspect, the invention provides a wall-mounted access control panel that includes one or more access control boards, each of which provides at least an interface for monitoring and/or controlling access to one or more building entry points or zones via associated sensors and/or intrusion prevention devices, collectively, “security devices.” The access control panel includes at least one connector disposed internal to the panel that provides communications coupling between at least one of the control boards and the aforementioned security devices (e.g., detectors, electrified locks, etc.). That connector permits such coupling without requiring that a field technician, or other person installing the panel at a site, pass and/or connect wires directly to the control boards from the security devices in order to establish that communications coupling.

### BACKGROUND OF THE INVENTION

The invention pertains to access/security control systems. It has application in the protection of buildings, homes, properties and people.

Access control typically refers to electromechanical security products/systems that monitor and control access in and out of buildings or other properties. Often, an access control system utilizes third party software to communicate with electronic panels that authorize a door to open, lock, be held, or any other combination of events through the use of electronic control hardware that is physically attached to the door.

The panels (referenced above) that are utilized for this process are typically connected to a computer server that controls access to each door by authorizing individuals with proper credentials to enter the space.

Literally, there are hundreds of companies that manufacture access control software and each of them manufactures their own access control panel that is intended to be mounted. These manufacturer's also sell separately the circuit boards that are in a typical panel/enclosure as a “board only” component (i.e. sold without the wall mounted panel).

A typical security integrator buys “board only” components and mounts them in enclosures (e.g., provided by the components manufacturer) for mounting. This often takes many hours and after mounting it takes many more hours in the field to make all of the connections.

An object of the invention is to provide improved access control panels and methods.

A further object is to provide such panels and methods as speed and lower the cost of installation and/or maintenance.

A yet still further object is to provide such panels and methods as can be used with control boards from multiple manufacturers.

### SUMMARY OF THE INVENTION

The foregoing objects are among those attained by the invention which provides, in some aspects, apparatus for access (or security) control comprising a wall-mounted access control panel that includes one or more access control boards, each of which provides at least an interface for monitoring and/or controlling access to one or more building entry points or zones via associated sensors and/or intrusion prevention devices, collectively, “security devices.” The access control panel includes at least one connector disposed internal to the panel that provides communications coupling between at least one of the control boards and the aforementioned security devices (e.g., detectors, electrified locks, etc.). That connector permits such coupling without requiring that a field technician, or other person installing the panel at a site, pass and/or connect wires directly to the control boards from the security devices in order to establish that communications coupling.

Further aspects of the invention provide such an access control panel in which multiple such connectors are provided, e.g., on a printed circuit board that comprises or is integral to, an interior portion of the enclosure. In such aspects, each connector can permit coupling as described above, between the control boards and the respective security devices.

Still further aspects of the invention provide such an access control panel as supports control boards comprising multiple different “platforms,” i.e., of different third-party (or other) manufacturers. In these aspects, the access control panel comprises a backplane on which the control boards are mounted (or otherwise disposed) and that comprise one or more arrangements of apertures, mounting pins, and the like supporting such mounting (or disposal). The access control panel further comprises power and electrical interfaces that support both the control boards and the security devices.

Further related aspects of the invention provide such an access control panel that includes a wiring harness that carries communications signals from the one or more connectors to the control boards.

Still further aspects provide methods for assembly, installation and use of access control panels as described above.

These and other aspects of the invention are evident in the drawings and text that follows.

### BRIEF DESCRIPTION OF THE ILLUSTRATED EMBODIMENT

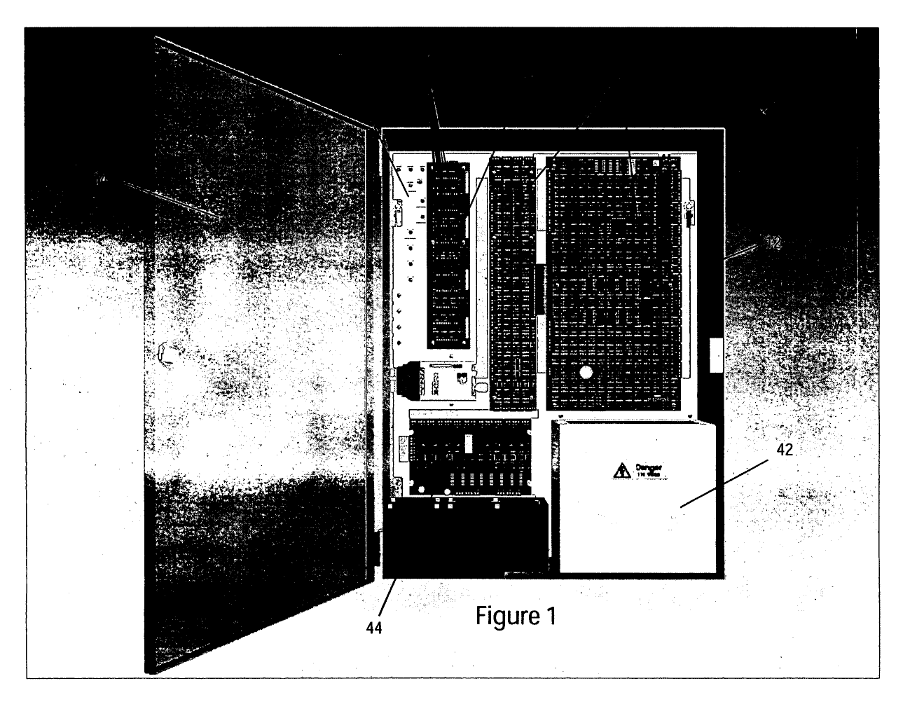

FIG. 1 depicts a wall-mounted access control panel according to one practice of the invention; and

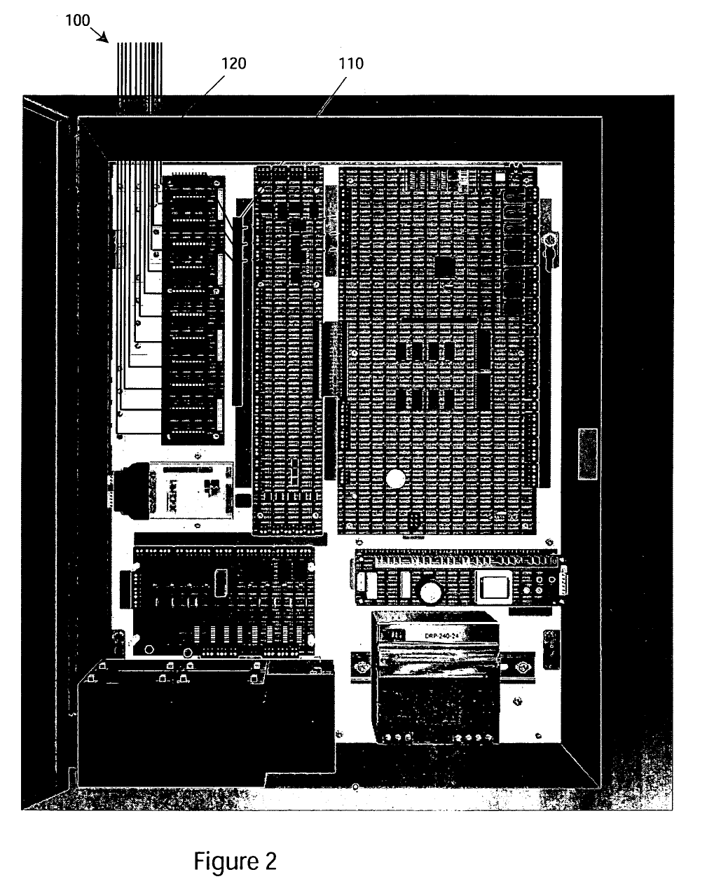

FIG. 2 depicts an interior portion of the enclosure of FIG. 1, including a circuit board having multiple connectors.

### DETAILED DESCRIPTION OF THE ILLUSTRATED EMBODIMENT

FIG. 1 depicts a wall-mounted access control panel 10 according to one practice of the invention. The panel 10 includes an enclosure 12 having a front panel 14, as shown. The enclosure 12 provides a rigid framework onto which mechanical, electromechanical, integrated circuit and other components (collectively, “components”) of the panel 10 are mounted and a housing structure that protects those components from dust, moisture, tampering, and so forth. In the illustrated embodiment, enclosure 12 comprises a metal wall-mount chassis with a hinged front panel 14 allowing access to the internal components of the access control panel 10. Illustrated enclosure 12 is composed of metal, though, in other embodiments it may be plastic, ceramic, composite, or otherwise.

Front panel 14 can include a display (not shown) that displays the status of access control panel 10. This can be a conventional LCD display, LED display or other display of the type known in the art. Moreover, the display can be provided within the interior of the enclosure 12 (necessitating that a technician or other person open the panel 14 in order to read the display) or elsewhere thereon.

Enclosure 12 can additionally include air flow apertures (not shown) that ensure a stable operating temperature within the enclosure. These may be provided on front panel 14 or elsewhere. Moreover, one or more fans (not shown) could, for example, circulate air through such openings, thereby cooling the components inside enclosure 12.

Enclosure 12 includes further components conventional to wall-mount panels, e.g., a power switch, a circuit breaker, a LAN (local area network) port, and so forth, all configured and operated in the conventional manner known in the art. One or more of these may be disposed on front panel 14, though, preferably, they are disposed elsewhere on or in the enclosure. Such a power switch (not shown), for example, allows a user to control electrical power to the panel 10 and may be, for example, a conventional toggle switch or otherwise. That switch may be operated manually, electronically, remotely, or otherwise. In the illustrated embodiment, the panel 10 is hardwired to a power source, although in other embodiments it may be powered otherwise. A circuit breaker (not shown), by way of further example, protects the components mounted inside (or outside) enclosure 12 from damage caused by overload or short circuit. It may comprise a conventional circuit breaker of the type conventionally used in the art. Some embodiments may obviate the need for such a circuit breaker 38, e.g., by building such functionality into individual components. A LAN port (not shown) serves as an interface between the access control panel 10 and an IP network (not shown), e.g., a switched IEEE 802.3 Ethernet network, or otherwise, via which panel 10 may be monitored or controlled and/or to which one or more sensors, intrusion prevention devices and other apparatus (collectively, “security devices”) monitored/controlled by the panel 10 may be coupled. By way of non-limiting example, such security devices can include door status contacts, motion detectors, glass break detectors, etc., and actuators, e.g., lights, alarms, locks, etc., although more complicated devices can be served as well.

FIG. 1 further depicts the internals of the wall-mounted access control panel 10. The panel 10 has components mounted on a base of enclosure 12, as shown. The illustrated components include access control boards 40, power supply 42, power distribution board 44, and an array of connectors 32, configured as shown. The access control boards 40 provide an interface for monitoring and/or controlling access to one or more building entry points or zones via associated security devices.

In the illustrated embodiment there are two access control boards 40 disposed within enclosure 12, each of the type conventionally used in the art of access control. Other embodiments may include a greater or lesser number of such boards 40, and/or combine the functionality of the control boards 40 with others of the illustrated components.

The illustrated power supply 42 and power distribution board 44, together, supply and control power to the control boards 40 and security devices in the conventional manner known in the art. The power distribution board 44 is implemented in printed circuit boards, though other form factors can be used. Moreover, although power supply 42 and power distribution board 44 are shown separately, in some embodiments, their functionality may be combined and/or distributed among other components of the access control panel 10.

Illustrated connectors 32 provide communications coupling, e.g., electrical connectivity, between the control boards 40 (e.g., via circuit board 50 and wiring harness 110 discussed below, or otherwise) and the aforementioned security devices (e.g., detectors, electrified locks, etc.). Additionally, the connectors 32 provide communications coupling between the control boards 40 and any expansions boxes that may be coupled thereto.

In the illustrated embodiment, each connector 32 has multiple conductors and screws, fast-locks, or other fastening devices that facilitate securing corresponding leads from cabling that lead to those security devices—and, thereby, establishing electrical connectivity to the control boards (again, e.g., via the circuit board 50 and wiring harness, or otherwise). To this end, connectors 32 can be selected or configured for securing leads to conventional analog or digital security devices. An advantage of utilization of connectors 32 is that the field technician, or other person installing the panel 10 at a site, can simply attach leads (e.g., cabling 100, discussed below in reference to FIG. 2) from the security devices to the connectors (rather than directly to the control boards themselves) in order to establish coupling between the control boards 40 and those security devices. This can, among other things, reduce obstruction within the panel 10, and facilitate maintenance of the panel.

With continued reference to FIG. 1, the illustrated enclosure 12 further includes a backplane 70 that provides for electrical grounding and physical mounting of access control boards 40. In the illustrated embodiment, it includes mount points (e.g., screw holes, mount pins, etc.) for access control boards of multiple different manufacturers, though, other embodiments may support a limited variety of such boards. Illustrated backplane 70 comprises stamped metal piecework, though, in other embodiments it comprise printed circuit boards or other fabrications.

FIG. 2 depicts, among other things, cabling 100 and a wiring harness 110 for use in the security panel 10. The illustrated cabling 100 provides communications coupling between the connectors 32 and the security devices. In the illustrated embodiment, the cabling comprises wires or leads of the type conventionally known in the art, albeit as adapted in accord with the teachings hereof. Although in the illustrated embodiment the cabling 100 enters enclosure 12 through a top portion 120 thereof, as shown, in other embodiments it may enter through one or more apertures disposed elsewhere, through a back panel of enclosure 12, etc.).

The illustrated wiring harness 110 provides electrical coupling and/or communications coupling between each of the connectors 32 and their respective control boards 40. In the illustrated embodiment, the harness 110 comprises an arrangement of one or more bundled wires fabricated in the conventional manner known in the art as adapted in accord with the teachings hereof. Though a wire bundle is used in the illustrated embodiment, other embodiments may use flexible circuit boards and so forth.

Described above are devices and methods meeting the aforementioned objects, among others. Those skilled in the art will appreciate that the embodiments discussed and shown herein are merely examples of the invention and that other embodiments fall within the scope thereof.

In view thereof, what we claim is:

1. An access control panel comprising
A. a wall-mount enclosure,
B. one or more access control boards disposed within the enclosure that
i. receive signaling from one or more sensors and/or intrusion prevention devices (collectively, “security devices”), and/or
ii. control access to one or more entry points and/or zones, and
C. at least one connector providing communications coupling between at least one of the access control boards and at least one of the security devices.

2. The access control panel of claim 1, wherein a plurality of connectors are mounted or disposed within an interior portion of the enclosure.

3. The access control panel of claim 2, wherein the connectors are integral to a circuit board mounted or disposed within the enclosure.

4. The access control panel of claim 1, wherein said at least one connector provides communication coupling between at least one of the access control boards and at least one of the security devices without requiring requiring that a field technician, or other person installing the panel at a site, pass or connect wire directly to the control boards from the security devices in order to establish that communications coupling.

5. The access control panel of claim 2, comprising a wiring harness that carries communication signals from the plurality of connectors to one or more control boards.

6. The access control panel of claim 5, wherein the wiring harness reduces cabling within the enclosure during installation of the panel, and/or facilitates maintenance of the panel.

7. The access control panel of claim 1, wherein the access control panel comprises one or more power and/or electrical interfaces that support the control boards and the sensors and/or intrusion prevention devices.

8. The access control panel of claim 1, wherein the enclosure comprises a backplane in which one or more access control boards are mounted or disposed.

9. The access control panel of claim 8, wherein the backplane comprises one or more arrangements of apertures and/or mounting pins to support mounting of the access control boards.

10. The access control panel of claim 8, wherein the access control boards comprise multiple different platforms.

11. The access control panel of claim 1, wherein the at least one connector is coupled to one or more of the security devices via cabling passed through a top portion of the enclosure.

12. An access control panel comprising
A. an enclosure configured for wall mounting,
B. one or more access control boards disposed within the enclosure that
i. receive signaling from one or more sensors and/or intrusion prevention devices, and
ii. control access to one or more entry points and/or zones, and
C. at least one connector providing communications coupling between at least one of the control boards and the sensors and/or intrusion prevention devices such that the coupling does not require passing a wire or cable directly to the control boards.

13. The access control panel of claim 12, wherein the enclosure comprises a wall-mounted panel with a hinged front portion.

14. An access control panel comprising
A. an enclosure configured for wall mounting,
B. one or more of any of power supplies, power distribution boards, and/or system control boards,
C. one or more access control boards,
D. an interchangeable backplane onto which one or more access control boards of different platforms and/or manufacturers can be mounted or disposed, and
E. at least one connector providing communications coupling between at least one of the control boards and the sensors and/or intrusion prevention devices such that the coupling does not require passing a wire or cable directly from the sensors and/or intrusion protection devices to the control boards.

15. A method of access security control, comprising
A. housing, with a wall-mounted enclosure, one or more access control boards
i. receiving signaling from one or more sensors and/or intrusion prevention devices, and/or
ii. controlling access to one or more entry points and/or zones, and
B. providing communications coupling, with at least one connector, between at least one of the access control boards and the sensors and/or intrusion prevention devices such that the coupling does not require passing a wire or cable from the devices directly to the control boards.

16. A method of claim 15, wherein a plurality of connectors are mounted or disposed on a circuit board disposed within the enclosure.

17. A method of claim 15, wherein each connector can permit coupling to one or more common control boards and/or one or more sensors and/or intrusion prevention devices.

18. A method of claim 15, comprising a wiring harness that carries communication signals from the one or more connectors to one or more control boards.

19. A method of claim 15, where the access control panel comprises one or more power and/or electrical interfaces that support the control boards and the sensors and/or intrusion prevention devices.

20. A method of claim 15, wherein the enclosure comprises a backplane in which one or more access control boards are mounted or disposed.

21. A method of claim 20, wherein the backplane comprises one or more arrangements of apertures and/or mounting pins to support mounting of the access control boards.

22. A method of claim 20, wherein the access control boards comprise multiple different platforms.

23. A method of access security control, comprising
A. housing, with an enclosure configured for wall mounting, one or more access control boards
i. receiving signaling from one or more sensors and/or intrusion prevention devices, and/or
ii. controlling access to one or more entry points and/or zones, and
B. providing communications coupling, with at least one connector disposed within the enclosure, between at least one of the access control boards and the sensors and/or intrusion prevention devices such that the coupling does not require passing a wire or cable directly from the sensors and/or intrusion prevention devices to the control boards.
